(19) United States
(12) Patent Application Publication
(10) Pub. No.: US 2005/0264689 A1
(43) Pub. Date: Dec. 1, 2005

(54) Display panel having a video camera

(76) Inventors: Shou An Yang, Tainan City (TW); Hsiang Yuan Yang Chen, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/882,199

(22) Filed: Jul. 2, 2004

(30) Foreign Application Priority Data
May 26, 2004 (TW) 093208209

(51) Int. Cl. H04N 7/14; H04N 5/225

(52) U.S. Cl. 348/373; 348/14.16

(57) ABSTRACT

A display panel having a video camera includes a web video camera set installed direct to a display panel. The web video camera set includes a video sensing chip and a signal connector deposed behind the display panel. The display panel is assembled on a monitor that is connected with a host, so that all images taken by the web video camera set will be transmitted to the host.

### BACKGROUND OF THE INVENITON

1. Field of the Invention

This invention relates to a display panel having a video camera, and more particularly to a web video camera set installed direct to a display panel for taking a picture or video without the frame of a monitor, which is more compact in size and convenient to carry.

2. Description of the Prior Art

With the fast expenditure of web technology, video transmission is also more popular to users. In order to achieve this transmission requirement, many peripherals are developed, such as microphones, speakers and web video cameras. Most notebook computers have installed a microphone and a speaker integrally. As to the web video cameras, there is still difficulty with the current technology. Users have to purchase a separate video camera and clip for the computer, which is very inconvenient.

As shown in FIGS. 3 and 4, a conventional web video camera set 4 is installed at the top center portion of a frame 31 of a monitor 3. The web video camera set 4 comprises a video sensing chip 41 and a signal connector 42 deposed behind a display panel 32 of the monitor 3. Because the web video camera set 4 is mounted direct into the frame 31 of the monitor 3, it is convenient to carry. But the frame 31 needs to be larger enough to accommodate the web video camera set 4.

In view of this, the inventor has derived the present invention to integrate a web video camera set to a display panel.

### SUMMARY OF THE INVENTION

It is the primary objective of the present invention to provide a display panel having a video camera, which is easy to operate.

It is another objective of the present invention to provide a display panel having a video camera, which saves space and is easy to carry for travel.

### BRIEF DESCRIPTION OF THE DRAWINGS

FIG. 1 is a front view of the present invention;

FIG. 2 is a side cross-sectional view taken along line A-A of FIG. 1;

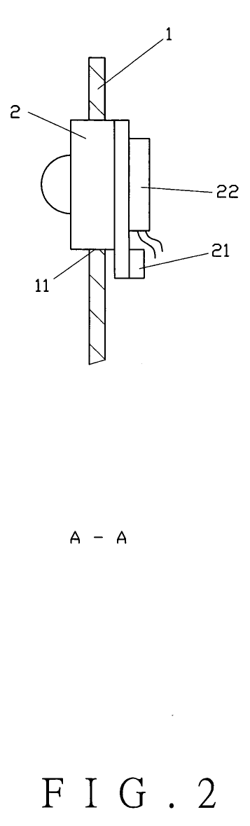

FIG. 3 is a front view of a prior art; and

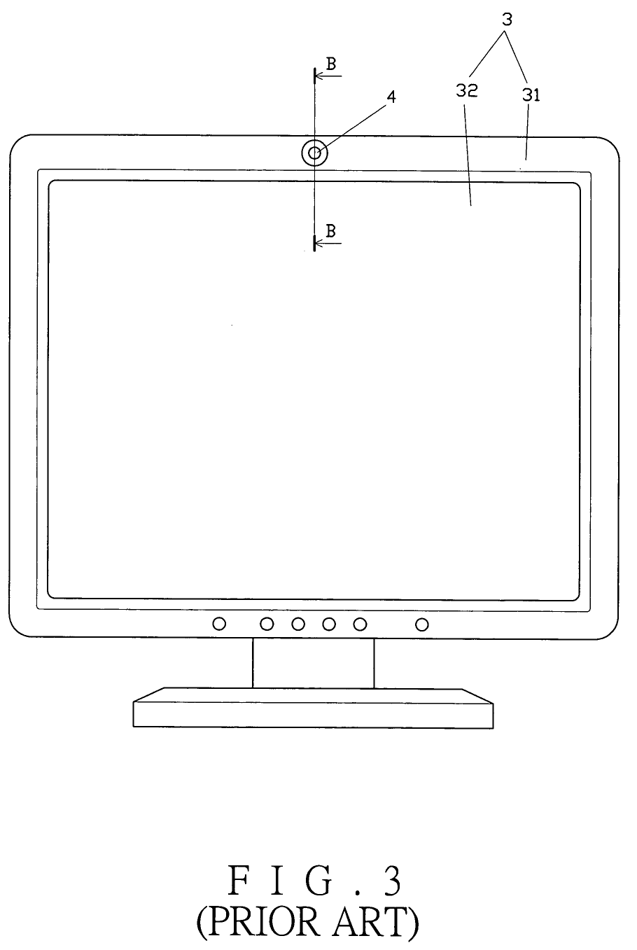

FIG. 4 is a side cross-sectional view taken along line B-B of FIG. 3.

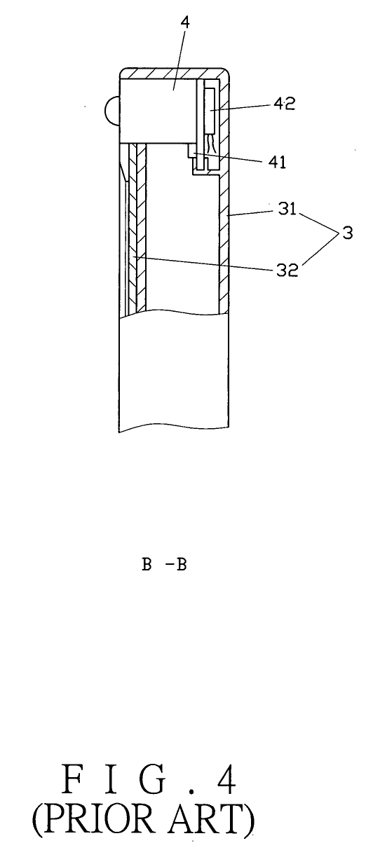

### DETAILED DESCRIPTION OF THE PREFERRED EMBODIMENT

The present invention comprises a video camera installed in a display panel which can be adapted to a LCD (Liquid Crystal Display)`TFT-LCD (Thin Film Transistor Liquid Crystal Display)`PDP (Plasma Display Panel)`FED (Field Emission Display)`LCOS (Liquid Crystal On Silicon)`OLED (Organic Light-Emitting Diode) or EL (Electro Luminescent Display) and so on for a computer, TV, cellular phone or surveillance system.

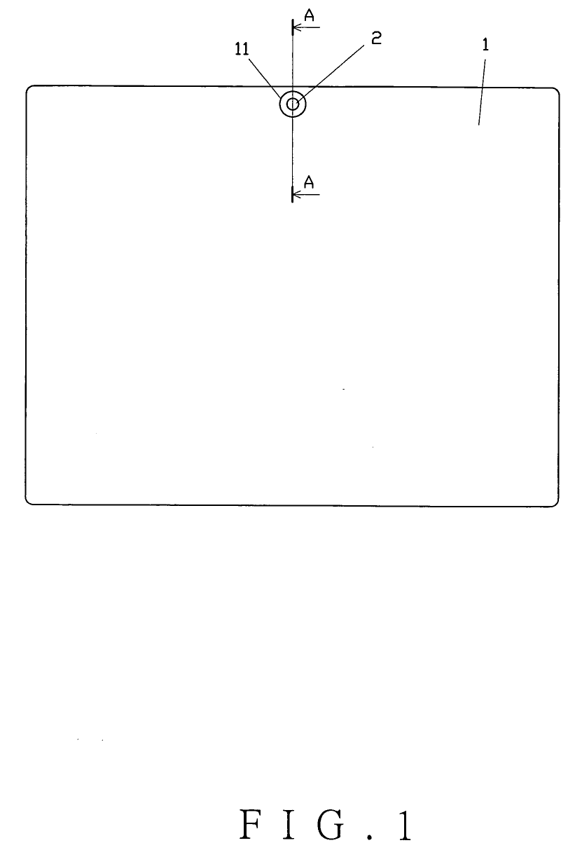

As shown in FIGS. 1 & 2, the present invention comprises a display panel 1 consisted of glass substrate`color filter`polarizer`backlight module. (The display panel is a prior technical skill and will not be described hereinafter) A web video camera set 2 is installed at the top center portion of the display panel 1. The web video camera set 2 comprises a video sensing chip 21 and a signal connector 22 deposed behind the display panel 1. The display panel 1 is drilled a hole 11 at the top center portion to accommodate the web video camera set 2 thereat, with a diameter corresponding to the outer diameter of the web video camera set 2. The gap between the hole 11 and the web video camera set 2 is sealed. Thus, the web video camera set 2 is securely installed in the display pane 1 to take a picture or video.

1. A display panel having a video camera comprising a web video camera set installed in a display panel, said display panel assembled on a monitor connected with a host, so that all images taken by said web video camera set are transmitted to said host.

2. The display panel having a video camera, as claimed in claim 1, wherein said display panel is drilled a hole to accommodate said web camera set.
